(19) United States
(12) Patent Application Publication
(10) Pub. No.: US 2010/0060073 A1
(43) Pub. Date: Mar. 11, 2010

(54) Bicycle Wheel with Rim for a Tubeless Tyre

(75) Inventors: Claudia Patricia Alfonso Felgar, Aveiro (PT); Alexandre Do Couto Gandarinho, N/A (PT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: RODI-METALURGICAS DO EIXO, S.A., Eixo-Aveiro, Aveiro (PT)

(21) Appl. No.: 12/521,739

(22) PCT Filed: Dec. 29, 2006
(86) PCT No.: PCT/PT06/00031

§ 371 Date: Nov. 16, 2009

(51) Int. Cl. B60B 21/06

(52) U.S. Cl. 301/58

(57) ABSTRACT

The present invention concerns a bicycle wheel with a rim for a tubeless tyre, characterised in that it is provided with a rim 1 intended to receive a number of fixing elements 6, which are in accordance with the number of spokes 2, such fixing elements being assembled by fitting and sliding between the wheel's hub 8 and the rim 1 and which are fixed into the desired positions. Therefor it is necessary to make special holes in the upper part of the rim 1 without the need to make any holes in the lower wall.

### SCOPE OF THE INVENTION

The present invention concerns a bicycle wheel with a rim for a tubeless tyre. The aluminium rim's profile configures an inner tube on which are introduced elements that shall support the spokes and permit their tightening between the wheel's hub and the said rim.

### PRIOR ART

Different bicycle wheels with rims, suitable to support tubeless tyres, are known. As it is common knowledge, a tubeless tyre requires a rim with no holes in the area receiving the tyre or, if any, they must be suitably insulated such that the tyre is air-tight inside. Therefor, the rims profile exhibit a characteristic configuration. Basically, the rim's profile is provided with a tube whereon are made the holes to fix the spokes. Such tube is peripherally developed next to the tyre supporting area. Alternatively, the rim of the prior art may not present a chamber suitable for the spokes holes but rather a sealing system for the holes that shall receive the spokes heads in the chamber that shall receive the tubeless tyre.

Among the documents of the prior art the following must be mentioned: U.S. Pat. No. 6,155,651, US 2004/0004391, US 2003/0025383, FR 2,829,969, EP 1,260,382 and EP 1,375,195.

Patent U.S. Pat. No. 6,155,651 concerns a bicycle wheel for a tubeless tyre of the type WO, the rim of this wheel being built such that it is able to be air-tight, reduce the wheel's weight and provide an easy way to fix a tyre. Particularly, a sealing material located inside a groove may have a reduced weight and the fixing of a tyre bead in the rim is readily done by placing the tyre bead inside the groove. This provides a system wherein a rim with a diaphragm is provided in the outer side of the rim, a hole that is formed in the diaphragm and which is appropriate for the spokes fixing head to pass through, which hole ? is made air-tight by means of a sealing material presented under the form of a metallic stripe and, when a tubeless tyre is filled with air, a soft foam is also to be bound to the upper surface of the sealing material, such that a portion of the tyre bead is easily placed on a portion whereon the tyre bead shall be laid, such that even a very thin portion of the tyre bead is easily sealed, following which the form of the laying portion of the tyre bead between a portion of the rim's flange and a bent portion of the rim presents a curved form to increase the sealing area, a valve is pressed against the diaphragm through a gasket and made air-tight, a hole for the assembling of the spokes is drilled in a portion of thick wall of the surface of the rim's body, and one spoke's end and the crown of a spoke's fixing head are received in a hollow portion.

Patent US 2004/0004391 concerns a rim to fit tubeless tyres, particularly for bicycles, motorcycles and motorized bicycles, consisting in a profiled element that is bent in a circular form and which is symmetrical in respect of a plan of centre lines, the said profiled element forming an outer annular valve and an inner annular laying valve which are divided by an annular partition provided with slots and arranged respective to the heads connected to the spokes of the said rim, a tyre of the tubeless kind being connected to the said outer annular laying valve, such that it forms a pressure tube. The rim includes some plugging elements which fit in the said slots, so that they hermetically separate the said outer annular laying valve of the said inner annular laying valve.

Patent US 2003/0025383 concerns a rim structure for a bicycle wheel which includes, in the periphery thereof, an annular channel intended for receiving a tyre, the said channel being outlined by an upper bridge devoid of openings, except the opening for the valve, and two side flanges, such flanges being provided with ends suitable to engage the tyre. The upper bridge has a rim central cavity, narrow and withdrawn, outlined by a base and by two side walls, the rim's cavity being outlined by two laying valves for the tyre bead which are slant between the rim's cavity and the flanges. The invention does also concern a wheel having such a rim and a wheel equipped with a tyre fitted without a tube and having such rim.

Patent FR 2,829,969 concerns a bicycle wheel expected to be assembled without a tube. The upper bridge of the wheel alloys has a central rib that laterally defines two slots wherein the tyre beads fit and are retained. The height of the slots is lower than the width thereof at the level of the rib's upper part, the height of the tyre beads exceeding the thickness thereof, this height being lower than the slots height and higher than the width thereof.

Patent EP 1,260,382 concerns a rim for a bicycle wheel that includes side portions with an outer portion that extends between the side portions, so that it forms a pair of outer corners, and a portion for the fixing of the spokes. The outer portion includes a pair of ribs spaced apart from the outer corners. Preferably, the ribs divide a pair of slant surfaces. The side portions do preferably include a pair of braking surfaces rectified with a pair of oblique surfaces that extend between the braking surfaces and a pair of outer side surfaces. A bicycle tubeless tyre is fitted on the rim including a portion of tread, a pair of side walls and a pair of tyre beads. Each of the tyre beads has an inner laying surface supported on one of the ribs. Preferably, each of the tyre beads has a reinforcing element with a central axis. Each of the ribs is preferably located between one of the central axis and an inner edge of one of the inner laying surfaces.

Patent EP 1,375,195 concerns a set of rim and spokes including an annular rim and a plurality of spokes. Each of the spokes is provided with a sealing structure that enables a tubeless tyre to be used with the rim. The rim has preferably an annular groove with a plurality of openings to fix the spokes. Each of the spokes has an outer end portion coupled to one of the openings to fix the spokes. Each of the spokes outer end portions includes a supporting element and a resilient sealing element that forms the sealing structure for the spoke. The supporting elements and the sealing elements are arranged and configured such that the supporting elements shall contact the spokes fixing portion in a selective manner, so that it prevents the total compression of the sealing elements when a radial force is applied on the supporting elements. The supporting elements may be separated from the spokes or be fully formed with the spokes.

### SUMMARY OF THE INVENTION

In the world of cycling, either in competition or leisure, both in road bicycles and mountain bicycles, the search for components wherein the weight may be as low as possible is well known. One of the bicycle components that may contribute the most for this reduction is doubtlessly the tyre and the respective rim on which it is fitted.

There are, therefore, several solutions for bicycle wheels wherein the tyres are not provided with air-tubes. Therefor, and as it was mentioned in the preceding chapter, the rims present a special configuration, which, nevertheless, may add some additional weight.

Furthermore, it is general knowledge that tubeless tyres are those which:

show less rolling resistance;

have a lower weight among all kinds of tyres;

permit a higher inflating pressure;

in the event of a swift deflation, do yet grant drivers greater stability and security.

These and other advantages force manufacturers to constantly search for solutions that may provide satisfaction to clients who are increasingly demanding.

Within this line of thought, the applicant conceived an innovating solution the main object of which consists in a rim suitable to fix tubeless tyres, i.e., a rim provided with a chamber wherein special holes are drilled for the introduction of the wheel spokes fixing elements.

Another object of the invention is the lightness of the rim, a factor much appreciated by the users of mountain or road bicycles.

A further object of the inventions is yet the easy way of placing the spokes in the bicycle wheel provided with a rim suitable to receive a tubeless tyre.

Other objects and advantages shall become apparent along this description.

### BRIEF DESCRIPTION OF THE DRAWINGS

The following description is based on the attached drawings of some preferred embodiments which are presented herein with no limiting character. In the drawings:

FIG. 1 depicts a bicycle's wheel rim according to the invention;

FIG. 2 depicts an exploded view of the rim and of the element to fix the spokes;

FIG. 3 depicts a cross-section view of the rim's profile;

FIG. 4 depicts another view of the rim with the assembled spokes; and

FIG. 5 depicts an exploded view of the element to fix the rays.

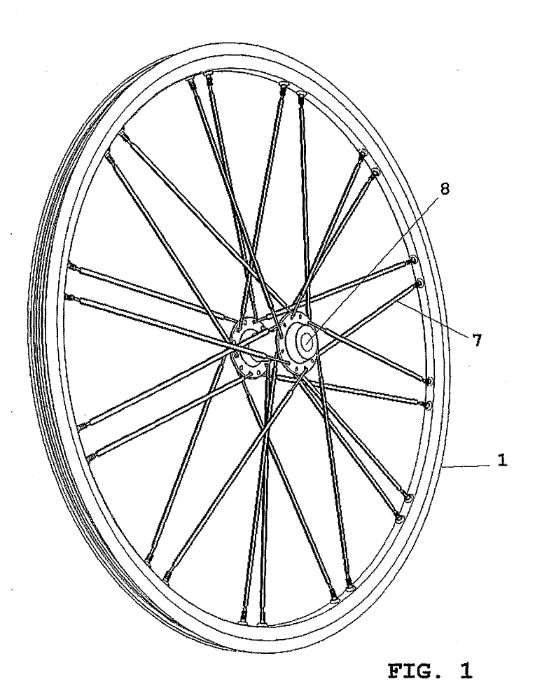

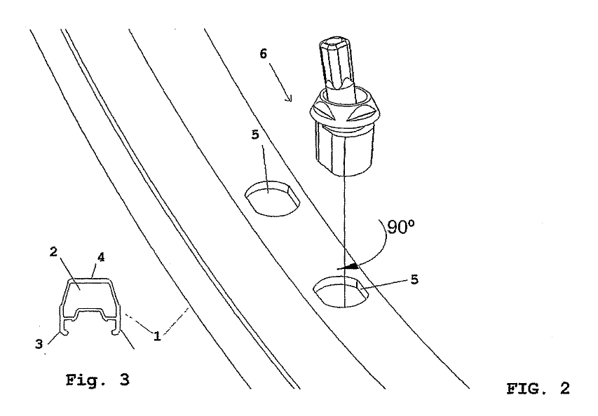

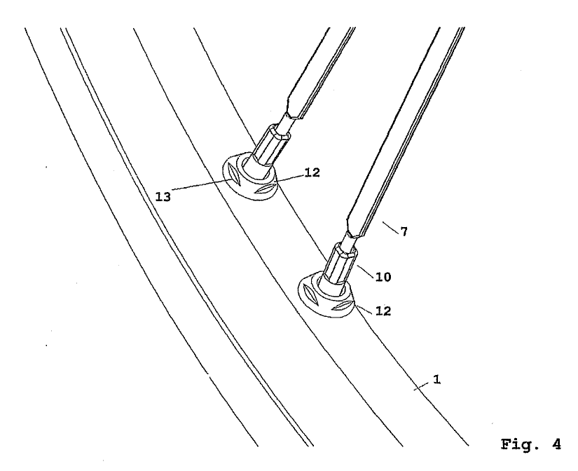

### DETAILED DESCRIPTION OF THE INVENTION

As it may be observed in the attached figures, the rim 1 for a bicycle wheel for tubeless tyres is shown with a profile having a “U” configuration with a transversal partition wall provided with a central channel between the legs 3 of the “U”, such wall determining a chamber 2. The tyre beads contact and are fixed onto the outward-turned edges of the “U” legs 3, such legs configuring, in the outer side, a braking flat zone against which the brake chocks shall act.

The said chamber 2 is perforated along the wall or bore 4 of the “U”. Perforations 5, to receive the fixing elements 6 for the spokes 7, have a substantially rectangular configuration, the minor sides of which being rounded, and the number of which is in accordance with the number of spokes which are intended to attach rim 1 to the wheel's hub 8.

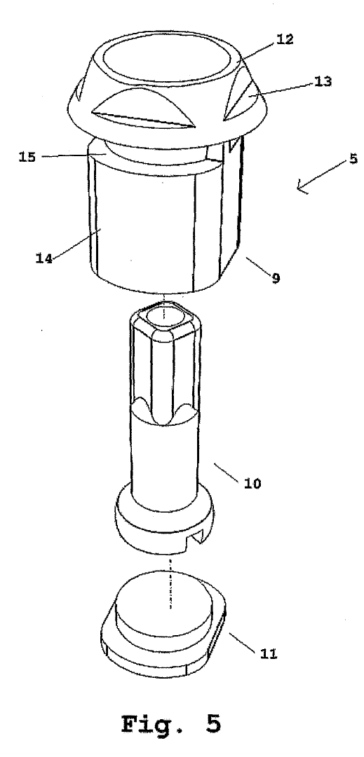

Fixing elements 6 are formed by one heads-holder 9, one head 10 and one element 11 sealing-off dirt and moist. As it may be observed in FIG. 5, the heads-holder 9 is provided with a hole drilled through and through to introduce head 10 to fix spoke 7 which, on its turn, fix the said spoke 7. Heads-holder 9 is provided with a base 14 which transversal section has a form that matches the form of perforation 5 and on the upper part of which is opened a slot 15. The heads-holder 9 is also provided with an upper part 12.

The assembling sequence is as follows: First, head 10 is assembled in the heads-holder 9 and the sealing element is put in place; next, heads-holder 10 is fitted in perforation 5 and turned 90° to effect the fixing thereof to rim 1 on the wall 4 of chamber 2; finally, the spoke is introduced therein and is conveniently tightened.

Tightening of the spoke 7, between rim 1 and hub 8, is sufficient to guarantee the fixing of the heads-holder 9. The said tightening is performed by acting on head 9. The upper part 12 of the heads-holder 9 is provided with facets 13 proper to cooperate with appropriate keys to promote the fixing thereof by means of a 90° rotation in perforation 5.

The sealing element 11 has a configuration that is adapted to the hole of the heads-holder 9 and is assembled after the introduction of head 10 in heads-holder 9 and immediately before the introduction of the element 6 to fix spoke 7 in perforation 5 of chamber 2 of the said rim 1.

What is claimed is:

1. Bicycle wheel with rim 1 for a tubeless tyre, characterised in that the said rim 1 has a profile with a “U” configuration with a transversal partitioning wall provided with a central channel between the “U” legs 3, such wall determining a chamber 2 and on which are practiced perforations 5 according to the number of rays 7 with which the said rim 1 is to be attached to the wheel's hub 8, which shall receive elements 6 to fix the said spokes 7, such fixing elements being initially fitted in the perforations and later on turned 90° to promote the fixation thereof on the walls of chamber 2.

2. Bicycle wheel with rim for a tubeless tyre according to claim 1, characterised in that the fixing element is formed by a heads-holder 9, a head 10 and an element 11 sealing-off dirt and moist, the said heads-holder 9 being drilled through and through for the introduction of fixing head 10 which, on its turn, fixes the said spoke 7.

3. Bicycle wheel with rim for a tubeless tyre according to claim 2, characterised in that perforations 5, proper to receive fixing
elements 6 for spokes 7, have a substantially rectangular configuration, the minor sides of which being rounded.

4. Bicycle wheel with rim for a tubeless tyre according to claim 3, characterised in that the tightening of spoke 7, between rim 1 and hub 8 is sufficient to guarantee the fixing of heads-holder 9.

5. Bicycle wheel with rim for a tubeless tyre according to claim 4, characterised in that heads-holder 9 has a base 14 which transversal section has a form that matches the form of perforation 5 and on the upper part of which is formed a slot 15 which shall promote, when fixing element 6 is rotated, the fixing thereof on wall 4 of chamber 2.

6. Bicycle wheel with rim for a tubeless tyre according to claim 5, characterised in that sealing element 11 has a configuration which is adapted to the hole of heads-holder 9.

7. Bicycle wheel with rim for a tubeless tyre according to claim 6, characterised in that the upper part 12 of heads-holder 9 is provided with facets 13 proper to cooperate with an appropriate tool which shall promote the tightening of spoke 7.
